(19) United States
(12) Patent Application Publication
(10) Pub. No.: US 2017/0199587 A1
(43) Pub. Date: Jul. 13, 2017

(54) Method for correcting motion sensor-related errors while interacting with mobile or wearable devices

(71) Applicant: 16Lab Inc., Kamakura (JP)

(72) Inventor: Rafael FERRIN, Tokyo (JP)

(73) Assignee: 16Lab Inc., Kamakura (JP)

(21) Appl. No.: 15/401,523

(22) Filed: Jan. 9, 2017

Related U.S. Application Data
(60) Provisional application No. 62/276,286, filed on Jan. 8, 2016.

(51) Int. Cl. G06F 3/0346; G06F 3/038

(52) U.S. Cl. CPC G06F 3/0346; G06F 3/0383

(57) ABSTRACT

The aim of the present method is to provide an instant and easy-to-use solution to compensate for common problems in sensing and analyzing orientation data provided by devices such as hand-held electronic devices (for example smartphones, remote controls, tablets, wands, etc.), and preferably in wearable miniature devices (for example smart jewelries, smart watches, smart wristbands, smart rings, etc.). The present method wherein the drift on the orientation or the error on the user pointing direction of the device is correctly adjusted regardless of the management of the orientation data.

### PRIORITY

This application claims priority of U.S. provisional application No. 62/276,286 filed on Jan. 8, 2016 and the contents of which are incorporated herein by reference.

### FIELD OF THE INVENTION

The present invention relates to the field of methods of interacting with mobile or wearable devices.

### PRIOR ART

Using a peripheral as input device is a transformation from the physical space, where the peripheral is used, to the virtual space of commands of the target device commands. In 3D orientation transformations, there are known problems with the drift error and additional errors made during the calculation of the 3D orientation caused by various specific reasons, such as being susceptible to earth gravity in the case of MEMS devices. For example, for a user wearing a smart wristband equipped with IMU (Inertial Measurement Unit) pointing at a certain direction using his/her finger, the direction detected by the wristband would be different from the intended direction of the user since the user would be using his/her finger as a pointing reference and not the wristband. This incompatibility and inaccuracy between the data detected by the target device and the one intended by the user results to incorrect input data. In the example, the problem, in turn, leads to the peripheral pointing at a wrong direction.

Various methods have been devised to improve human-machine interaction methods related to drift coming from gyro sensors. There are two principles of sensor detection fault processes: hardware redundancy and analytical redundancy. Hardware redundancy employs several sensors with correlated readings of a signal while analytical redundancy principle banks on mathematical models of the scheme being quantified to yield an expected value. These two schemes can be either used independently from each other or in combination.

As a related patent example, WO0148571 serves as an example of analytical redundancy scheme. It uses Principal Component Analysis (PCA), Partial Least Squares (PLS), and dynamic Multivariable Predictive models to detect, identify, and classify faults in sensor measurement. Similarly, WO2016089442 describes a hardware redundancy scheme in which it utilizes a plurality of sensors such as a gyroscope, a drift detector and adjuster, a magnetometer, and an accelerometer to control input devices.

One disadvantage of the analytical redundancy technique is that it depends on an estimated value of a measured variable thereby requiring an accurate system model. It requires an extensive high quality operational data to work. This is also true for hardware redundancy scheme. The requirement of replication and/or sensor models that are valid in practice is one of the issues of hardware redundancy scheme since a failure in method is probable if sensor models are not satisfied. In addition, to requiring a high-quality data to work, the hardware redundancy scheme is also costly.

### BRIEF DESCRIPTION OF THE INVENTION

The aim of the present method is to provide an instant and easy-to-use method for interacting with orientation data provided by devices such as hand-held electronic devices (for example smartphones, remote controls, tablets, wands, etc.), and preferably in wearable miniature devices (for example smart jewelries, smart watches, smart wristbands, smart rings, etc.).

The aim of the presented invention is to compensate for the described problems by a method wherein the drift on the orientation or the error on the user pointing direction of the device is correctly adjusted regardless of the management of the orientation data. When pointing at a random direction and activating a trigger, instead of trying to use the real orientation of the device, which is wrongly calculated and does not accurately correspond to the pointing direction that the user is trying to use as input, the present invention is going to set a predefined starting orientation and use the changes on the calculated orientation of the peripheral at each iteration to also change the virtual orientation.

The consequence of this virtual orientation is that the relative movements of the peripheral matches almost perfectly with the relative movements that the OS is detecting. The usage of the data is, therefore, easy and simple for the human and for the OS.

The starting orientation for each new movement does not depend on the real orientation of the peripheral but on a decision made by the OS; it could always start at the same orientation, or at the most recent virtual orientation calculated on previous movements.

### BRIEF DESCRIPTION OF THE DRAWINGS

The preferred embodiment of present invention is explained more precisely with references to figures added, wherein

FIG. 1 illustrates the problem known from prior art, wherein the user 301 wearing smart wristband 302 points to screen 303. The user points using their finger as a point of reference in the direction 201 to the point 101 on the screen, but the wristband, using the sensor orientation direction as a reference, is actually pointing in the direction 202 to the point 102 on the screen. In addition, when the drift is introduced, the target device considers that the wristband is pointing to the point 103 on the screen. Using the point 103 to place a pointer confuses user, because in many cases it will be very different from point 101 to which user actually points, rendering the system unusable.

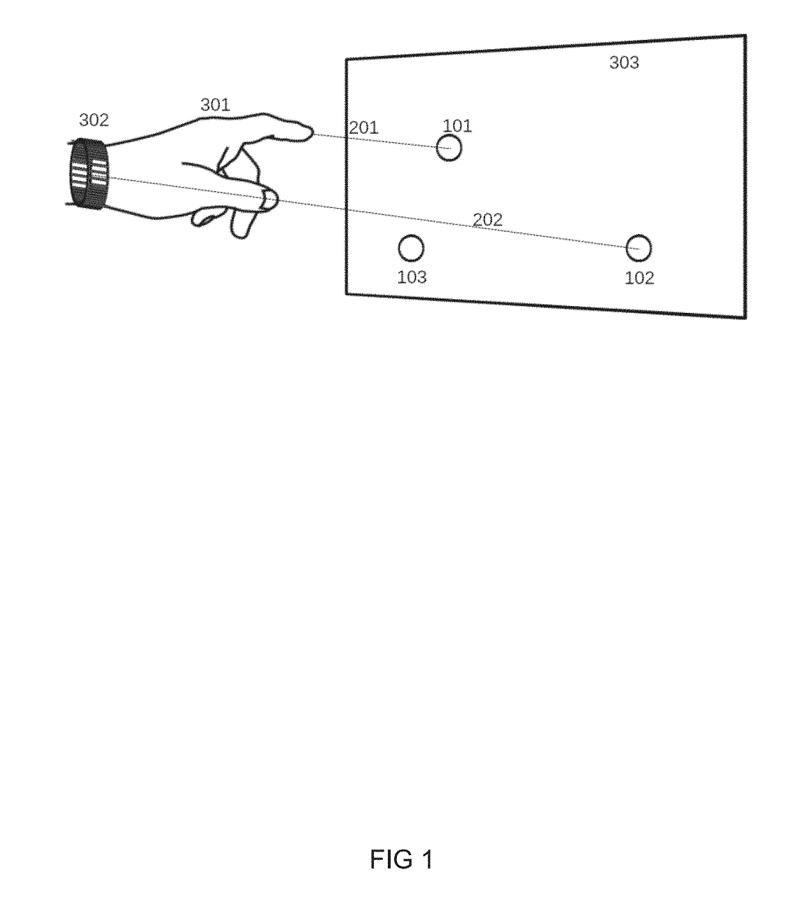

### DETAILED DESCRIPTION OF THE INVENTION

When the orientation of the peripheral is calculated by the target device, the actual orientation of the peripheral and the calculated one might not match. In general:

ƒ(x₀,x)=Oₑ≠Oᵣ

Where x is the sensor data, x₀ represents the previous values of the sensor data, ƒO is the algorithm to calculate the orientation used by the target device, Oₑ is the estimated orientation of the peripheral and Oᵣ is the actual real orientation of the peripheral in space. In addition, the orientation that the user is trying to use as input for the target system does not correspond with the real orientation of the peripheral

Oᵤ≠Oᵣ,

where Oᵤ is the orientation that the user is trying to use as input for the target device:

ƒ(x0,x1)=Oₑ₁≠Oᵣ₁

ƒ(x0,x2)=Oₑ₂≠Oᵣ₂

Δ(drift)=(Oₑ₂−Oₑ₁)−(Oᵣ₁−Oᵣ₂)≈0

Furthermore, taking into account that the orientation difference between the pointing direction of user's reference point and the actual direction of the peripheral device is usually within a small range (≦20° deg). Therefore

(Oᵤ₂−Oᵤ₁)≈(Oᵣ₁−Oᵣ₂),

where comparing the increment of the error (drift) between two successive calculations and the changes on the orientation of the user pointing direction and the changes on the orientation of the peripheral pointing direction

(Oᵤ₂−Oᵤ₁)≈(Oₑ₁−Oₑ₂),

which can be also written as:

ΔOᵤ≈ΔOₑ,

means that the changes on the estimated orientation of the peripheral calculated by the target device can be used to calculate the changes of the virtual orientation of the user pointing direction. Therefore, this invention is introducing a method using virtual orientation (Oᵥ) fulfilling these conditions

g(x₀,x₀)=Oᵥ₀=Oₑ₀+Oₖ.

The starting estimated orientation is modified by a constant transformation (Oₖ) to match with the desired starting orientation of the algorithm. Consequence of this constant transformation and the previous assumptions is

ΔOᵥ=ΔOₑ,

demonstrating changes on the virtual orientation will match with the changes of the estimated orientation. To not to accumulate the errors of Oₑ into the Oᵤ, and according to the assumptions made, the virtual orientation must be reset often. In the present method, it is reset every new movement, for example.

The method according to present invention for interacting with mobile or wearable devices using at least one inertial measurement unit (IMU) sensor data as input data comprises steps of:
1. predefining a pointing direction on the device axes (X axis, for example);
2. assuming that the user is using a pointing direction similar to the wearable pointing direction (finger pointing more or less in the X axis direction, for example);
3. predefining a starting virtual orientation;
4. activating the trigger;
5. acquiring data from at least one sensor;
6. using the data to calculate the change on the device orientation;
7. using that change on the device orientation to modify the virtual orientation;
8. using the updated virtual orientation as input for the OS algorithms (for example, for drawing a cursor on the screen);
9. freezing or resetting the virtual orientation while the trigger is deactivated (depending on the desired behavior).

The method according to present invention is explained by following example:
1. The user points to any direction and activate a trigger.
2. A cursor appears on the center of the screen.
3. The user turns his arm up-down-right-left and the cursor moves in the same direction, a distance proportional to the turned angle of the arm.
4. The user releases the trigger when the cursor is on the desired position of the screen.
5. Now the cursor is fixed on that position and the user can activate other functions or actions if available and desired.
6. Whenever the user wants to move the cursor again, he points in any direction, activates the trigger and continue according to step 3.

Depending on the target device configuration, each new movement could start again on the center of the screen, at the previous cursor position or in any other position that the target device decides according to other criteria. If the user wants to have the feeling that the cursor is actually moving to the place where he is pointing, he only needs to start pointing on the actual direction of the cursor position at every new movement, and the movement will be quite similar (it depends on the distance from the user to the screen).

Predefining the pointing direction is done by acquiring data samples from the motion sensor and processing them.

The virtual orientation is calculated using IMU data acquired from the sensors of peripheral device.

Activating the trigger is achieved by using a button, a touch sensor, a gesture or a voice command, as well as any other action performed by user that can be senses and interpreted as a trigger.

Acquiring data means capturing data from sensors and subsequently either storing them in a temporary memory and processing them, or transmitting the data to the target system where these data are then stored and processed.

Calculating the change of the device orientation is performed either by the peripheral itself or by the target device wherein the algorithm is used to carry out the calculations using the motion data.

The calculating the virtual orientation is performed by the peripheral itself or by the target device by comparing the changes in peripheral orientation.

Modifying the calculated virtual orientation is performed by the peripheral itself or by the target device by comparing the changes in peripheral orientation.

Updating the modified virtual orientation is performed by performing an analysis of the data using running window comparing one or more data samples in teal time. This step may be carried out by peripheral or by the target system.

Target system function represents any output function, such as an interface on a screen, a projected interface, or any feedback or interface based on visual, aural, haptic or olfactory means of interaction.

1. A method for correcting motion sensor-related errors while interacting mobile or wearable devices with target devices using at least one inertial measurement unit (IMU) sensor data as input data, said method comprising the steps of
predefining a pointing direction on the device X, Y or Z axes;
detecting position and pointing direction of user's mobile or wearable device and user's finger pointing direction and calculating whether the user's finger pointing is more or less in same axis as the predefined pointing direction of the device;
predefining a starting virtual orientation;
activating a trigger;
acquiring data from at least one sensor of device;
calculating change of the device orientation by using the IMU data of device;
modifying the calculated virtual orientation by using said change on the device orientation;
updating the modified virtual orientation;
calculating target device function by using the updated virtual orientation as input;
freezing or resetting the virtual orientation, while the trigger is deactivated depending on desired behavior.

2. The method according to claim 1, wherein predefining the pointing direction is done by acquiring data samples from a motion sensor and processing them.

3. The method according to claim 1, wherein the virtual orientation is calculated using IMU data acquired from the sensors of peripheral device.

4. The method according to claim 1, wherein activating the trigger is achieved by using a button.

5. The method according to claim 1, wherein activating the trigger is achieved by using a touch sensor.

6. The method according to claim 1, wherein activating the trigger is achieved by using a gesture command.

7. The method according to claim 1, wherein activating the trigger is achieved by using a voice command.

8. The method according to claim 1, wherein activating the trigger is achieved by using any other action performed by user that can be sensed and interpreted as a trigger.

9. The method according to claim 1, wherein acquiring data means capturing data from sensors and subsequently either storing the data in a temporary memory or processing the data.

10. The method according to claim 1, wherein acquiring data means transmitting the data to the target system where these data are then stored and processed.

11. The method according to claim 1, wherein the calculating the change of the device orientation is performed by the peripheral itself.

12. The method according to claim 1, wherein the calculating the change of the device orientation is performed by the target device wherein an algorithm is used to carry out the calculations using the motion data.

13. The method according to claim 1, wherein the calculating the virtual orientation is performed by the peripheral itself.

14. The method according to claim 1, wherein the calculating the virtual orientation is performed by the target device by comparing the changes in peripheral orientation.

15. The method according to claim 1, wherein modifying the calculated virtual orientation is performed by the peripheral itself.

16. The method according to claim 1, wherein modifying the calculated virtual orientation is performed by the target device by comparing the changes in peripheral orientation.

17. The method according to claim 1, wherein updating the modified virtual orientation is performed by performing an analysis of the data using running window comparing one or more data samples in teal time and carried out by peripheral.

18. The method according to claim 1, wherein updating the modified virtual orientation is performed by performing an analysis of the data using running window comparing one or more data samples in teal time and carried out by target system.

19. The method according to claim 1, wherein target system function represents any output function, such as an interface on a screen, a projected interface, or any feedback or interface based on visual, aural, haptic or olfactory means of interaction.
